(19) United States
(12) Patent Application Publication
(10) Pub. No.: US 2026/0109287 A1
(43) Pub. Date: Apr. 23, 2026

(54) CARGO STRAP WITH MULTI-ANCHOR ENDPOINTS

(71) Applicant: Ancra International LLC, Hebron, KY (US)

(72) Inventor: Joaquim Carlos DA ROSA, Independence, KY (US)

(21) Appl. No.: 19/361,971

(22) Filed: Oct. 17, 2025

Related U.S. Application Data
(60) Provisional application No. 63/709,844, filed on Oct. 21, 2024.
(60) Provisional application No. 63/844,472, filed on Jul. 15, 2025.

(51) Int. Cl. B60P 7/08

(52) U.S. Cl. CPC B60P 7/083

(57) ABSTRACT

A cargo strap with multi-anchor endpoints can have various features. In some examples, the strap can include a tension distributor that joins the multiple anchor points to a main strap. In some examples, the cargo strap can include a tether that extends between straps of the multiple anchors. In some cases, the cargo strap can include a higher load capacity than a conventional strap (e.g., webbing) with connection hardware (e.g., E-track fitting, F-track fitting, etc.).

### CROSS REFERENCE TO RELATED APPLICATIONS

This application claims the priority benefit of U.S. Provisional Application No. 63/844,472 (filed Jul. 15, 2025) and claims the priority benefit of U.S. Provisional Application No. 63/709,844 (filed Oct. 21, 2024). Each of the aforementioned applications is incorporated herein by reference in its entirety.

### BACKGROUND

Cargo can be transported by various types of containers, such as an open trailer, closed trailer, box truck, van, pickup truck, shipping container, and the like. Sometimes, these structures can include anchor points (e.g., recesses, openings, slots, etc.) along the walls, ceilings, floors, etc. to secure hardware that is on tie-down equipment (e.g., straps, netting, beams, bars, etc.). In some instances, these anchor points can be part of a logistics track, logistics panel, or other logistics structure.

### DESCRIPTION OF DRAWINGS

The present subject matter related to a cargo strap with multi-anchor endpoints is described in detail below with reference to these figures:

FIG. 1 depicts a cargo control device with a tension distributor, in accordance with examples of this disclosure;

FIG. 2 depicts the tension distributor of FIG. 1, in accordance with examples of this disclosure;

FIG. 3 depicts an alternative tension distributor, in accordance with examples of this disclosure;

FIG. 4 depicts an alternative tension distributor, in accordance with examples of this disclosure; and

FIG. 5 depicts a cargo control device with a tension distributor and with tethered end straps, based on an example of this disclosure.

### DETAILED DESCRIPTION

This detailed description is related to a cargo strap with multi-anchor endpoints. In some examples, the cargo strap can include, near at least one of the endpoints, a tension distributor that can contribute to the cargo strap and related hardware having a higher load capacity than a conventional strap (e.g., webbing) with connection hardware (e.g., E-track fitting, F-track fitting, etc.). In at least some examples, the cargo control device includes a first strap (e.g., main strap) with a first end portion and a second end portion. In addition, the cargo control device includes a tension distributor coupled to each end portion (e.g., first tension distributor attached to first end portion and second tension distributor attached to second end portion). Furthermore, the cargo control device includes two or more additional straps connected to each tension distributor, and each of the additional straps can include hardware for engaging a logistics recess, hole, opening, slot, etc. (e.g., E-track, F-track, A-track, etc.).

At least some conventional devices include a strap (e.g., webbing) with connection hardware at each end (e.g., E-track fitting, F-track fitting, A-track fitting, etc.). These conventional straps with hardware can be extended from one connection point (e.g., a sidewall with logistics recess or slot) to another connection point (e.g., the opposing sidewall with logistics recess or slot) to restrain, secure, or otherwise control cargo inside a cargo transport structure (e.g., trailer, van, car, truck, etc.) However, the connection hardware typically includes a lower load rating than the strap. As such, in many instances with conventional solutions and based on the limited load capacity of the hardware fittings, multiple straps must be used to adequately secure cargo. Multiple straps can be cumbersome and time consuming to install, organize, store, and maintain.

In addition, adding more straps can introduce tripping or other safety hazards. In contrast to conventional devices, the present disclosure includes, one or more ends of the cargo strap, multiple anchor points. For example, a cargo strap of the present invention can include a tension distributor positioned near each end of the main strap, and at least two additional straps attached to the tension distributor, each additional strap with a respective hardware connector (e.g., track fitting). As such, the load capacity can be evenly distributed from the main strap to the two or more hardware connectors, which effectively increases the load capacity of the overall strap assembly. That is, a device of the present disclosure increases the capacity associated with a single main strap with fittings and reduces the number of straps that might need to be installed to safely and effectively control cargo.

In at least some examples of the present invention, at least one end of the strap can include multiple anchors, such as multiple straps, each with a respective track fitting. In addition, a tether strap can extend between the multiple straps to increase the likelihood that the track fittings are oriented in the track slots in a manner that reduces the likelihood of forces being unevenly distributed across the track fittings.

As used herein, the terms “about”, “approximately” and “substantially” mean +/−10% of a given value, such as a dimensional value (e.g., height, width, etc.). In addition, with respect to an angle, or the terms parallel and perpendicular, the terms “about” and “substantially” mean within 10 degrees. If “about” or “substantially” are otherwise used, the terms can, where appropriate, include equivalents of the modified element.

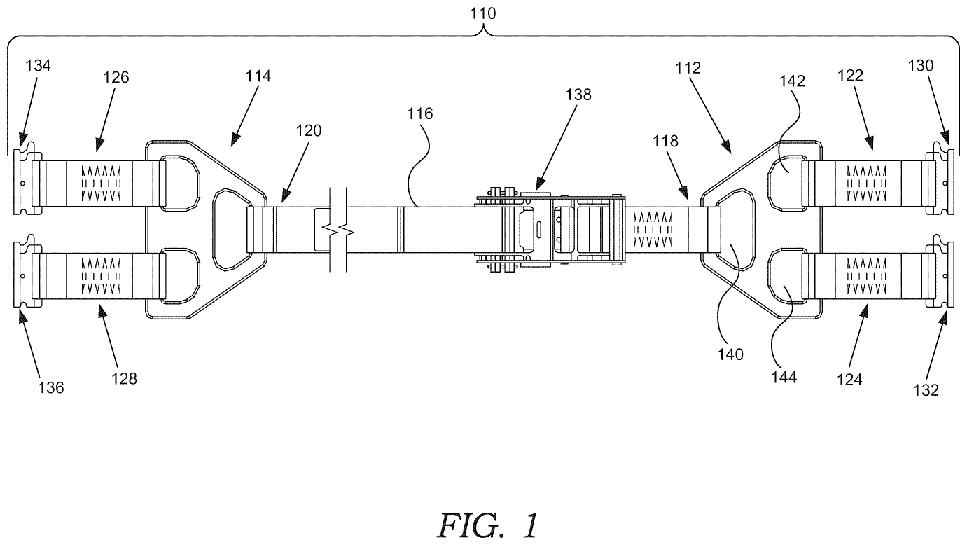

Referring now to FIG. 1, FIG. 1 depicts a cargo control device 110 with a tension distributor (e.g., 112 and/or 114) based on an example of this disclosure. In examples, the cargo control device 110 can include a first strap 116 (e.g., main strap) with a first end portion 118 and a second end portion 120. The first end portion 118 is coupled to a first tension distributor 112, and the second end portion 120 is coupled to a second tension distributor 114. In addition, a second strap 122 and a third strap 124 are coupled to the first tension distributor 112, and a fourth strap 126 and a fifth strap 128 are coupled to the second tension distributor 114. Each of these additional straps 122, 124, 126, and 128 can include hardware 130, 132, 134, and 136 (respectively) for connection to anchor points, such as openings, recesses, slots, etc. (e.g., E-track opening, F-track opening, A-track opening, and the like). As indicated above, the load capacity can be evenly distributed from the first strap 116 to the two (or more) hardware connectors (e.g., on each side), which effectively increases the load capacity of the cargo control device 110 (e.g., as compared to a strap with a single hardware connector on each end).

In some examples, the hardware 130, 132, 134, and 136 can include any combination of fitting types. For example, the hardware 130, 132, 134, and 136 can include any combination of E-track, A-track, F-track, etc. In addition, the hardware 130, 132, 134, and 136 can include any combination of hooks, latches, or other hardware connectors that can engage an opening, slot, hole, recess, or other anchor point (e.g., on the wall, floor, or ceiling of the cargo transport structure).

In examples, the straps 116, 122, 124, 126, and 128 can include one or more various types of straps used or usable in the cargo control industry for securing cargo or loads. For example, the straps 116, 122, 124, 126, and 128 can include any webbing (e.g., polyester webbing, nylon webbing, etc.) having a width between 1″ and 4″. In some examples, the straps 116, 122, 124, 126, and 128 can include 2″ webbing. In some examples, the straps 116, 122, 124, 126, and 128 can include webbing with smaller widths or webbing with larger widths. In some examples, the straps 116, 122, 124, 126, and 128 all include the same width. In some examples, the one or more of the straps 116, 122, 124, 126, and 128 can include a width that is different from one or more of the other straps 116, 122, 124, 126, and 128.

In at least some examples, the strap 116 can include a length adjuster 138 that can adjust the length of the strap 116 between the first end portion 118 and the second end portion 120. For example, the strap 116 can include a ratchet buckle, cam buckle, slide buckle, or other type of strap length adjuster.

Conventionally straps might include a hardware connector at each end portion (e.g., 118 and 120), and sometimes, the conventional hardware connector can have a lower load rating than the strap 116. In contrast to conventional devices, an example of the present disclosure includes the first tension distributor 112 coupled to the first end portion 118 and the second tension distributor 114 coupled to the second end portion 120. In addition, each tension distributor 112 and 114 is coupled to a respective set of additional straps with hardware connectors. In at least one example, a tension distributor 112 and 114 is coupled to at least two additional straps, each with a hardware connector/fitting. In some examples, a tension distributor 112 and 114 can be coupled to more than two additional straps, each with a hardware connector/fitting.

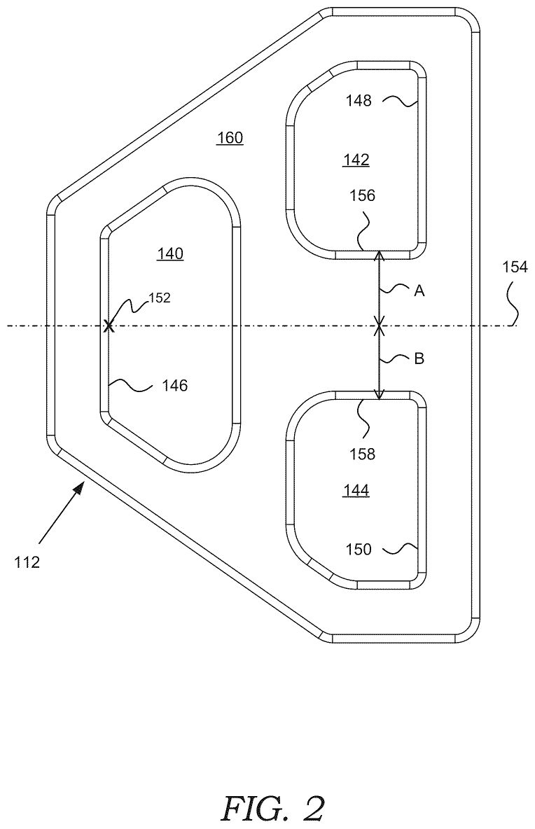

For brevity, the tension distributor 112 is described in greater detail (e.g., FIG. 2), and the same or similar description can equally apply to the tension distributor 114. In some examples, when assembled to the first strap 116, the tension distributor 114 mirrors the tension distributor 112. In combination, the first tension distributor 112 and the second tension distributor 114 can be a tension distribution assembly.

In at least some examples, a tension distributor 112 can include a plate having one or more openings for receiving a portion of the straps. For example, the tension distributor 112 can include a first opening 140, a second opening 142, and a third opening 144. In examples, the first strap 116 can include a portion (e.g., end portion 118) extending through the first opening 140. For example, the end portion 118 can be passed through the first opening 140 and affixed (e.g., stitched) back onto itself. In addition, the second strap 122 can include a portion extending through the second opening 142 (e.g. and affixed back onto itself); and the third strap 124 can include a portion extending through the third opening 144 (e.g. and affixed back onto itself).

In examples, the tension distributor 112 is configured to distribute the load from the first strap 116 evenly between the second strap 122 and the third strap 124. For example, the openings 142 and 144 can be positioned relative to the first opening 140 such that when the respective strap is secured in the respective opening, the straps are positioned relative to one another to evenly distribute the load. This even distribution can be achieved in various manners. In at least one example, the first opening 140 includes a first edge 146 (e.g., perimeter edge of the opening 140), which the first strap 116 can extend around when connecting to the tension distributor 112. In addition, the second opening 142 can include a second edge 148, which the second strap 122 can extend around when connecting to the tension distributor 112, and the third opening 144 can include a third edge 150, which the third strap 124 can extend around when connecting to the tension distributor 112.

In some examples, the first edge 146 can be parallel to the second edge 148 and to the third edge 150. In examples, a parallel orientation of the edges can affect the orientation of the straps (e.g., help the straps to also extend in a parallel orientation), which can contribute to even load distribution. For example, when the edges 146, 148, and 150 are parallel, then the straps 116, 122, and 124 can also extend parallel to one another.

In at least some examples, the first edge 146 includes a midpoint 152 aligned with a midpoint reference line 154, which extends perpendicular to the first edge 146 and through the midpoint 152 and between the second opening 142 and the third opening 144. In addition, the second opening 142 includes a first inner edge 156 and the third opening includes a second inner edge 158 that are equidistant (e.g., reference arrows A and B) from the midpoint reference line 154. In some examples, this equal spacing can help to evenly distribute load from the main strap 116 to the two additional straps 122 and 124 and their respective hardware. For example, each of the inner edges can operate to limit and confine movement of the respective strap towards the midpoint reference line 154, which can help to maintain even spacing and resulting load distributions.

In at least some examples, the spacing between the first inner edge 156 and the second inner edge 158 (e.g., the combination of “A” and “B”) is configured based on the standardized spacing associated with a logistics track or panel. As such, when the fittings 130 and 132 are inserted into anchor points (e.g., logistics slots, recesses, or openings), then the straps 122 and 124 can be more likely to evenly distribute load.

Although FIG. 2 depicts the edges 146, 148, and 150 as relatively straight edges, in some examples the edges could have bumps or protuberances or protrusions (e.g., teeth), such as for increasing frictional engagement with the straps.

In examples, the tension distributor 112 can include a relatively flat plate. For example, the tension distributor can include a relatively planar first face 160 and a relatively planar opposing second face (not shown in the figures). In addition, the tension distributor 112 can include a thickness between the first face and the second face (e.g., a relatively constant thickness). The thickness can vary depending on the material and application or intended use, and in some examples, the thickness is in a range between about 0.25″ and about 0.375″ or about 0.30″ (although the thickness can be smaller than 0.25″ or larger than 0.375″). In addition, the openings 140, 142, and 144 can extend entirely through the plate. The tension distributor can compositionally include various materials, such as metal (e.g., aluminum, steel, etc.), polymer (e.g., HDPE or other high strength polymer), wood, carbon, composite, carbon fiber, etc.

In examples, the tension distributor 112 can include a single continuous plate of material. The openings 140, 142, and 144 can be cut, molded, stamped, cast, or otherwise formed in the plate.

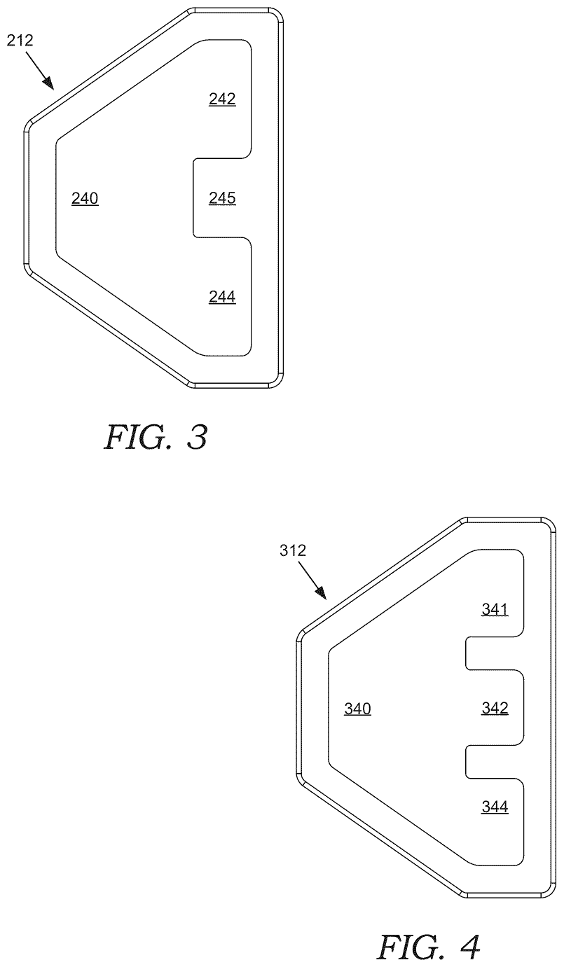

Referring to FIG. 3, an alternative tension distributor 212 is depicted in which the openings 240, 242, and 244 are continuous with one another, and the divider portion 245 of the plate helps to maintain spacing between the straps to contribute to even load distribution.

In at least some examples, more than two additional straps can be joined to the tension distributor. For example, FIG. 4 depicts an example, in which 3 additional straps could be affixed to the tension distributor (e.g., in openings 341, 342, and 344), in addition to the main strap (e.g., in opening 340).

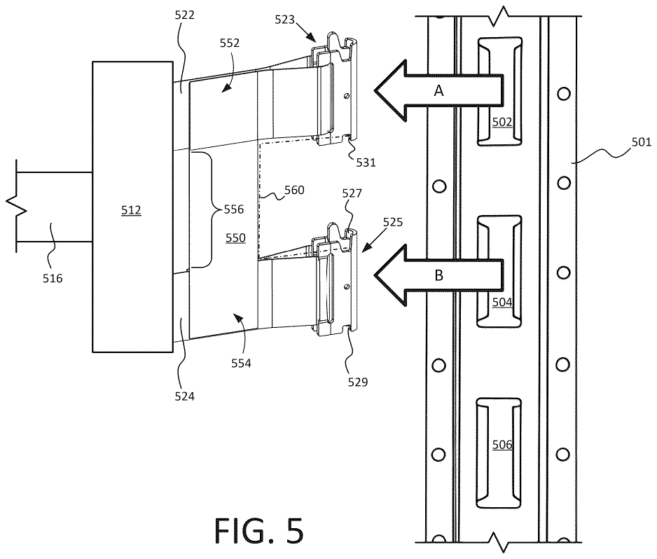

In examples of the present invention, a cargo control device can have at least two additional straps that are attached to a tension distributor. For example, FIG. 5 includes a first additional strap 522 and a second additional strap 524 that are attached to strap hardware 512, such as a tension distributor or other hardware that can connect the additional straps 522 and 524 to a main strap 516. For example, the strap hardware 512 can include any one or more features of any of the tension distributors described in this disclosure (e.g., the tension distributor 112 or the tension distributors in FIG. 3 or FIG. 4). The strap hardware 512 can also, or alternatively, include other types of strap hardware that can join the additional straps 522 and 524 to the main strap 516. In at least some examples, a cargo control device of the present disclosure can include the fittings 523 and 525, which can be releasably connected to an E-track. In some examples, a cargo control device can include other types of fittings that can be used to releasably connect to E-track or other types of logistics tracks (e.g., F-track, A-track, etc.) or other types of recess for anchoring the straps.

FIG. 5 also includes an example vertical E-track 501 with a first E-slot 502, a second E-slot 504, and a third E-slot 506. The E-track 501 is just one example of the type of track that can be used with a cargo control device of the present disclosure, and in other examples, a different style of track can be used with a different style of slot. In at least some cases, it can be preferable for the pulling force that is applied to each additional strap 522 and 524 (and to the respective fitting 523 and 525 on the end of the additional straps 522 and 524) to be normal to the surface of the logistics track 501 (e.g., as represented by the arrows A and B). This arrangement with the pulling force normal to the surface of the logistics track 501 can increase the maximum break strength, such as by evenly distributing forces across the contact points (e.g., 527 and 529) of the fittings.

In at least some examples, a cargo control device of the present disclosure can include a tether 550 that is attached to, and extends between, the first additional strap 522 and the second additional strap 524. The tether 550 can include webbing or other type of elongated member, such as rope, bungee, cable, wire, etc. The tether 550 can include a first end portion 552 that is coupled to the first additional strap 522, a second end portion 554 that is coupled to the second additional strap 524, and a middle portion 556 between the first end and the second end that extends between, and operatively joins, the first additional strap 522 and the second additional strap 524. For example, the tether 550 can be stitched to the first strap 522 and the second strap 524 or attached by any other suitable attachment mechanism.

In examples, the tether 550 can restrict the distance by which the fittings 523 and 525 can be spread apart, which can restrict the ability to skip an opening in the logistics track when attaching the cargo control device to the track. Absent the present disclosure, a slot in the logistics track can be more easily skipped, such as when a first fitting is installed and the straps are spread apart to attach the second fitting in a non-adjacent slot opening. In at least some instances, if a slot in the logistics track is skipped (e.g., the fitting 525 is attached to the slot 506 while the fitting 523 is attached to the slot 502), then the pulling force might no longer normal to the track, and the forces applied to the fitting(s) might no longer be evenly distributed. For example, if a force is no longer normal, then an uneven force can be applied to the first track engagement point 527 of the fitting 525 as compared to a force applied to a second track engagement point 529 of the fitting 525. More specifically, the shortest distance between source of the pulling force and either of the engagement points 527 and 529 might possibly carry a majority of the load, creating stress concentration. In turn, the stress concentration can reduce the maximum break strength of the fitting(s).

In at least some examples, the tether 550 (e.g., the middle portion 556 of the tether) is long enough to allow a user or operator to manipulate the fitting(s), while also being short enough to reduce one's ability to skip a slot. The length of the middle portion 556 of the tether 550 can depend on the distance between slots. In addition, the length of the portion of the straps 522 and 524 that extends between the tether and the hardware 523 and 525 can also be configured to allow for user manipulation, while also impeding the operator from skipping a slot. For example, in some instances the combined distances 560 (e.g., represented by dot-dash line) from the engagement point 531 to the tether middle portion 556, the length of the middle portion 556 from one strap 522 to the other strap 524, and from the middle portion 556 to the engagement point 527 can be configured to allow the fitting 523 to engage in the slot 502 and prevent the engagement point 529 from connecting in the slot 506.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

1. A cargo control device comprising:
a first strap having a first end portion and a second end portion;
a first tension distributor attached to the first end portion of the first strap;
a second strap attached to the first tension distributor and comprising a first hardware connector configured to connect to a first anchor point;
a third strap attached to the first tension distributor and comprising a second hardware connector configured to connect to a second anchor point;
a second tension distributor attached to the second end portion of the first strap;
a fourth strap attached to the second tension distributor and comprising a third hardware connector configured to connect to a third anchor point; and
a fifth strap attached to the second tension distributor and comprising a fourth hardware connector configured to connect to a fourth anchor point.

2. The cargo control device of claim 1, wherein the first strap comprises a length adjuster.

3. The cargo control device of claim 2, wherein the length adjuster comprises a ratchet.

4. The cargo control device of claim 1, wherein the first tension distributor comprises a plate with a first opening, a second opening, and a third opening; and wherein the first strap extends through the first opening, the second strap extends through the second opening, and the third strap extends through the third opening.

5. The cargo control device of claim 4, wherein the first opening comprises a first edge, the second opening comprises a second edge, and the third opening comprises a third edge; and wherein the first edge is parallel to the second edge and to the third edge.

6. The cargo control device of claim 4, wherein the first tension distributor comprises a continuous plate comprising a thickness; and wherein the first opening, the second opening, and the third opening each extends through the thickness.

7. The cargo control device of claim 6, wherein the continuous plate comprises a metal plate.

8. The cargo control device of claim 4, wherein the second tension distributor comprises a plate with a fourth opening, a fifth opening, and a sixth opening; and wherein the first strap extends through the fourth opening, the fourth strap extends through the fifth opening, and the fifth strap extends through the sixth opening.

9. The cargo control device of claim 8, wherein the fourth opening comprises a fourth edge, the fifth opening comprises a fifth edge, and the sixth opening comprises a sixth edge; and wherein the fourth edge is parallel to the fifth edge and to the sixth edge.

10. The cargo control device of claim 8, wherein the second tension distributor comprises a second continuous plate comprising a second thickness; and wherein the fourth opening, the fifth opening, and the sixth opening each extends through the second thickness.

11. The cargo control device of claim 10, wherein the continuous plate comprises a metal plate.

12. A tension distribution assembly for a cargo strap, the tension distribution assembly comprising:
a first tension distributor attachable to a first end portion of the cargo strap, the first tension distributor comprising:
a first plate with a first thickness;
a first opening extending through the first thickness;
a second opening extending through the first thickness; and
a third opening extending through the first thickness; and
a second tension distributor attachable to a second end portion of the cargo strap, the second tension distributor comprising:
a second plate with a second thickness;
a fourth opening extending through the second thickness;
a fifth opening extending through the second thickness; and
a sixth opening extending through the second thickness.

13. The tension distribution assembly of claim 12, wherein the first plate comprises a first continuous plate body and the second plate comprises a second continuous plate body.

14. The tension distribution assembly of claim 12, wherein the first plate and the second plate compositionally comprise a metal.

15. The tension distribution assembly of claim 12, wherein the first opening comprises a first edge, the second opening comprises a second edge, and the third opening comprises a third edge; and wherein the first edge is parallel to the second edge and to the third edge.

16. The tension distribution assembly of claim 15, wherein the fourth opening comprises a fourth edge, the fifth opening comprises a fifth edge, and the sixth opening comprises a sixth edge; and wherein the fourth edge is parallel to the fifth edge and to the sixth edge.

17. The tension distribution assembly of claim 12, wherein:
the first opening comprises a first edge having a first midpoint:
the second opening comprises a first inner edge oriented towards the third opening;
the third opening comprises a second inner edge oriented towards the second opening;
a midpoint reference line extends through the midpoint and between the first inner edge and the second inner edge; and
the first inner edge and the second inner edge are equidistant from the midpoint reference line.

18. A cargo control device comprising:
a first strap having a first end portion and a second end portion;
a second strap attached to the first end portion and comprising a first hardware connector configured to connect to a first anchor point;
a third strap attached to the first end portion and comprising a second hardware connector configured to connect to a second anchor point;
a first tether connected to the second strap and the third strap;
a fourth strap attached to the second end portion and comprising a third hardware connector configured to connect to a third anchor point;
a fifth strap attached to the second end portion and comprising a fourth hardware connector configured to connect to a fourth anchor point; and
a second tether connected to the second strap and the third strap.

19. The cargo control device of claim 18, wherein the first tether is connected to the second strap at a first position between the first end portion and the first hardware connector and is connected to the third strap at a second position between the first end portion and the second hardware connector.

20. The cargo control device of claim 18, wherein the first end comprises a first tension distributor and the second strap and the third strap are coupled to the first tension distributor; and wherein the second end comprises a second tension distributor and the fifth strap and the sixth strap are coupled to the first tension distributor.
